(19) United States
(12) Patent Application Publication
(10) Pub. No.: US 2006/0240207 A1
(43) Pub. Date: Oct. 26, 2006

(54) Multi-layered coextruded biaxially stretched fibre-improved seamless tube covering and use thereof as a food covering

(75) Inventors: Wilhelm Tobben, Kassel (DE); Heinrich Henze-Wethkamp, Walsrode (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 10/568,008

(22) PCT Filed: Aug. 2, 2004
(86) PCT No.: PCT/EP04/08631

§ 371 Date: Mar. 13, 2006

(30) Foreign Application Priority Data
Aug. 12, 2003 (DE) 10337009.9

(51) Int. Cl. B32B 1/08

(52) U.S. Cl. 428/36.91

(57) ABSTRACT

At least three-layered, coextruded, tubular, biaxially stretched seamless tubular casing comprising, viewed from the outside inwards, a) an outer layer A which comprises as the main component a polyamide or a mixture of several polyamides, b) optionally a layer B which has an oxygen-blocking character, c) optionally a core layer C which comprises as the main component a polyamide or a mixture of several polyamides, d) a layer D which has an adhesion-promoting action with respect to the adjacent layer C or B or A and the adjacent layer E and e) an inner layer E which comprises as the main component a polyamide or a mixture of several polyamides, f) optionally further layers and additives, wherein g) at least one layer comprises natural fibres having a fibre length in the range of from 5 to 10,000 μm and/or a natural fibre mixture of various fibre types and/or fibre lengths. The use thereof as a foodstuffs casing is also described.

The present invention relates to a tubular, seamless, at least 3-layered biaxially stretched, shrinkable nature-identical tubular casing for permanent and wrinkle-free wrapping of paste-like or liquid goods, in particular foodstuffs, which is characterized by a high water vapour and oxygen barrier and provides very good use properties.

Seamless synthetic casings are often employed for wrapping paste-like or liquid goods for production and/or packaging purposes. The use of such casings for the production and/or packaging of scalding and boiling sausages, processed cheese, soups or pastes of high fat content are a typical use. However, depending on the goods to be produced or to be packaged, extensive specific requirements must be met in order to comply with uses in practice.

In the production of sausages, for example, these use properties requirements can include:
good barrier properties
resistance to heat up to the sterilization temperature
good adhesion to the filling
good tear propagation resistance during storage under heat
adequate shrinkage
high strength, dimensional stability, tautness
good peeling properties, easy peelability
good hot and cold slicing properties
good dippability, in particular cold and hot dippability
easy fabrication, in particular gatherability
good colourability and colour covering
good printability and reliable adhesion of printing ink
acceptability according to foodstuffs law (EC guidelines, Bundesamt für gesundheitlichen Verbraucherschutz und Veterinärmedizin GBVV, Food and Drug Administration FDA)
ecological acceptability of the materials used

In addition, nature-identical haptical properties and a visually pleasing appearance, such as is already known for collagen and cellulose fibre guts with or without a barrier layer, is ever more frequently required.

The multi-layered, biaxially stretched, seamless casings known to date on the market are tailor-made specifically for the production and/or packaging of meat products, in particular sausage, and meet the abovementioned use requirements to a greater or lesser degree.

However, a visually pleasing product is particularly required by the customer. A casing which is suitable for the uses mentioned is accordingly characterized by the following core properties, in addition to or in deviation from the requirements profile described above for sausage casings:
nature-identical visual properties and haptical properties in order to give the impression of a particularly fine product.
exceptionally good use and, in particular, mechanical properties, such as, for example, hot slicing, cold dipping, tear propagation resistance during hot storage and calibre constancy and cylindricity.

It is known from Savic, Z.: Sausage Casings, VICTUS Lebensmittelindustriebedarf, Vienna, Austria, p. 245-300 that many sausage casings meet many of the abovementioned requirements, but no casing is known which additionally has a nature-identical fine appearance, in addition to excellent use properties.

The European Application EP-A-0 107 854 (Kureha, III.4, Oct. 1, 1982) describes a tubular, 5-layered laminate comprising an inner layer of thermoplastic resin, a middle layer of vinylidene chloride copolymer (PVDC), an outer layer of olefin resin and two adhesive layers between the main layers. The casing contains as a component halogen-containing PVDC, the use of which is ecologically unacceptable and therefore is accepted less and less nowadays. Furthermore, the typical shine and the typical smooth surface of a tubular casing of plastic is common to this casing, leaving the consumer with an unpleasantly synthetic impression.

DE-A-40 01 612 (Kalle, XI.20, Jan. 20, 1990) discloses a tubular, biaxially stretched casing coextruded in 3 layers having an inner and outer layer of polyamide or a polyamide-containing polymer blend and an oxygen-blocking middle layer of aromatic polyamide or copolyamide. The typical shine and the typical smooth surface of a tubular casing of plastic is common to this casing, leaving the consumer with an unpleasantly synthetic impression.

DE-A-43 39 337 (Naturin, II.14, Nov. 19, 1993) describes a 5-layered tubular casing for packaging and wrapping of paste-like foodstuffs. This tubular casing, in particular sausage casing, based on polyamide is characterized in that it is built up from an inner and an outer layer of the same polyamide material comprising at least one aliphatic polyamide and/or at least one aliphatic copolyamide and/or at least one partly aromatic polyamide and/or at least one partly aromatic copolyamide, a middle polyolefin layer and two adhesion promoter layers made of the same material. The content of the partly aromatic poiyamide and/or copolyamide is 5 to 60%, in particular 10 to 50%, based on the total weight of the polymer mixture of partly aromatic and aliphatic polyamides and copolyamides. The disadvantage of this casing is the typical shine and the typical smooth surface of a tubular casing of plastic, leaving the consumer with an unpleasantly synthetic impression.

EP-A-0 879 560 (Kalle, XI.35, May 21, 1997) discloses an at least 4-layered, biaxially stretched foodstuffs casing having two oxygen barrier layers. The oxygen barrier action is substantially effected here by an EVOH-containing layer which does not lie on the outside and a layer containing polyamide with aromatic contents which lies on the outside. The typical shine and the typical smooth surface of a tubular casing of plastic is common to this casing, leaving the consumer with an unpleasantly synthetic impression.

It is known that a certain change in the surface shine can be achieved by the use of inorganic additions in the outer layer or by an additional printing operation, but this usually has the disadvantage of looking synthetic due to a regular structure. There is furthermore an additional expenditure on time and finance for printing the casing.

The tubular casings described here for the prior art have deficiencies in individual points in respect of the properties profile described above. In particular, the casings known on the market show deficiencies in respect of the features of good barrier properties, good use properties, in particular mechanical properties, and pleasing appearance due to their nature-identical visual properties and haptical properties. A casing which fulfils these properties is not known to date.

There was therefore the object of developing a seamless tubular casing which meets the requirements profile mentioned, in particular in respect of an appropriate appearance due to nature-identical visual properties and haptical properties, and which has excellent use properties, in particular very good mechanical strength and good barrier properties.

The present invention achieves this object by providing an at least three-layered, preferably five-layered, coextruded, tubular, biaxially stretched, fibre-modified seamless tubular casing, at least one of the layers comprising natural fibres having a fibre length in the range of from 5 to 10,000 μm.

The present invention provides the process for the production of such a tubular, biaxially stretched, seamless casing. The tubular casing according to the invention is expediently produced via an extrusion process. The raw material in fibre, granule or powder form is compressed, melted and homogenized in an extruder and discharged via a die and shaped into a seamless tube. The primary tube emerging is cooled by means of air- or water-cooling and then simultaneously stretched biaxially. A particularly suitable process in this context is simultaneous biaxial stretching by means of double bubble technology, in which the stretching of the primary bubble takes place via an internal pressure which is applied. The casing can subsequently be subjected to a heat treatment for targeted adjustment of the shrinkage properties.

It is known that thermal and mechanical damage may occur during processing of natural fibres. Thermal damage manifests itself by inhomogeneities, such as e.g. in the form of specks and/or burns. Mechanical damage can be detected by an undesirable reduction in fibre length and fibre diameter and the distribution thereof. Surprisingly, it has been possible for natural fibre to be mixed into the polyamide matrix without significant thermal damage. By a suitable process procedure, it has been possible here simultaneously to adjust the mechanical damage to the fibres as required. It was furthermore surprising that the haptical and visual properties of the casing produced were similar to those of a collagen or cellulose fibre gut with and without a barrier layer, with a more economical production. Astonishingly, the mechanical properties of the casing were very good. It was thus possible to dip and gather the tube without this bursting or propagating tears during subsequent scalding. The barrier properties, such as, for example, permeability to water vapour and oxygen, can be adapted via the fibre content, so that use in tubular casings having a reduced barrier action and a natural appearance is also conceivable. An oxygen barrier is known to prevent premature greying of the cooking product facing the inside of the casing during storage. The water vapour barrier is known to prevent the weight loss of the product for sale which is induced by evaporation of water from the filling during storage, which on the one hand reduces the profit of the product and on the other hand can lead to wrinkled unattractive products as a result of volume shrinkage.

The build-up of the tubular casing has a total thickness of 5-150 μm at diameters of 5-500 mm and has the following composition:
Layer A: outer layer with the possibility of being printed on
Layer B: second outermost layer (between the outer layer and middle layer)
Layer C: middle layer
Layer D: second innermost layer between the inner layer and middle layer
Layer E: inner layer in contact with the filling

The natural fibres are mixed into at least one of the layers, preferably into layer A and/or B and/or C and/or D and/or E, and one or more layers can optionally be omitted or added.

The outer layer A which can be printed on without pretreatment comprises as the main component either an aliphatic homopolyamide or an aliphatic copolyamide or a blend of aliphatic homo- and copolyamide or a blend of aliphatic homo- or copolyamide and a partly aromatic polyamide. Suitable aliphatic homo- and copolyamides are those polyamides such as described in a general manner in Kunststoffhandbuch Part 3/4 “Polyamide” page 22 et seq., Carl Hanser Verlag Munich Vienna 1998. The aliphatic polyamide is a homopolyamide of aliphatic primary diamines and aliphatic dicarboxylic acids or a homopolymer of ω-aminocarboxylic acids or lactams thereof. The aliphatic copolyamide contains the same units and is e.g. a polymer based on one or more aliphatic diamines and one or more dicarboxylic acids and/or one or various ω-aminocarboxylic acids or lactams thereof. The aliphatic primary diamines contain, in particular, 4 to 8 C atoms. Suitable diamines are tetra-, penta-, hexa- and octamethylenediamine, and hexamnethylenediamine is particularly preferred. The aliphatic dicarboxylic acids contain, in particular, 4 to 12 C atoms. Examples of suitable dicarboxylic acids are adipic acid, azelaic acid, sebacic acid and dodecanedicarboxylic acid. The ω-aminocarboxylic acids and lactams thereof contain 6 to 12 C atoms. An example of ω-aminocarboxylic acids is 11-aminoundecanoic acid. Examples of lactams are ε-caprolactam and ω-laurolactam. Particularly preferred aliphatic polyamides are polycaprolactam (PA 6) and polyhexamethyleneadipamide (PA66). A particularly preferred aliphatic copolyamide is PA 6/66, which consists of caprolactam units, hexamethylenediamine units and adipic acid units. Partly aromatic polyamides are described in Kunststoffhandbuch Part 3/4 “Polyamide” page 803 et seq., Carl Hanser Verlag Munich Vienna 1998.

In the partly aromatic polyamides and copolyamides, either the diamine units can predominantly or exclusively form the aromatic units, while the dicarboxylic acid units are predominantly or exclusively of an aliphatic nature, or the diamine units are predominantly or exclusively of an aliphatic nature while the dicarboxylic acid units predominantly or exclusively form the aromatic units. Examples of the first embodiment are partly aromatic polyamides or copolyamides in which the aromatic diamine units consist of m-xylylenediamine and phenylenediamine. The aliphatic dicarboxylic acid units of this embodiment usually contain 4 to 10 C atoms, such as e.g. adipic acid, sebacic acid and azelaic acid.

In addition to the aromatic diamine units and the aliphatic dicarboxylic acid units, aliphatic diamine units and aromatic dicarboxylic acid units can also additionally be present in amounts of in each case up to 5 mol %. A particularly preferred embodiment comprises m-xylylenediamine units and adipic acid units. This polyamide (PA-MXD6) is marketed e.g. by Mitsubishi Gas Chemical Company Inc. under the name MX-Nylon. Examples of this second embodiment are partly aromatic polyamides and copolyamides in which the aliphatic diamines usually contain 4 to 8 C atoms. Among the aromatic dicarboxylic acids, isophthalic acid and terephthalic acid are to be singled out in particular. In addition to the aliphatic diamine units and the aromatic dicarboxylic acid units, aromatic diamine units and aliphatic dicarboxylic acid units can also additionally be present in amounts of in each case up to 5 mol %.

A particularly preferred embodiment comprises units of hexamethylenediamine, isophthalic acid and terephthalic acid. This polyamide (PA6I/6T) is marketed e.g. by DuPont De Nemours under the name Selar PA. The partly aromatic polyamide PA6I/6T is preferably added in amounts of between 2 and 40 wt. % per layer, in particular between 5 and 20 wt. %. The partly aromatic polyamide PA-MXD6 is preferably added in amounts of between 5 and 40 wt. % per layer, in particular between 10 and 30 wt. %. In addition, layer A can include additives, such as lubricants, antiblocking agents, nucleating agents, fillers and coloured pigments, or a mixture of these.

The second outermost layer B comprises an approximately completely hydrolysed ethylene/vinyl acetate copolymer (EVOH) having an ethylene content of from 25 to 53% by weight, preferably from 29 to 38% by weight. The layer thickness is between 2 and 30 μm, in a preferred embodiment between 2 and 8 μm, particularly preferably between 3 and 6 μm. Layer B can optionally comprise the polymers and additives mentioned in the description of layer A or layer D, but can optionally have a different composition to layer A or be omitted entirely.

The middle layer C comprises the polymers and additives mentioned in the description of layer A, but optionally has a different composition to layer A or can optionally comprise polyolefin homo- or copolymer or a blend of these having a melting point of the lowest-melting component of at least 110° C. Layer C can optionally also comprise the polymers and additives mentioned in the description of layer B, but optionally can have a different composition to layer B or be omitted entirely.

The second-innermost layer between the middle layer C and inner layer E is the adhesion-promoting layer D. This preferably comprises modified polyolefins. These are modified homo- and copolymers of ethylene or propylene and optionally further linear α-olefins having 3 to 8 C atoms, which contain grafted-on monomers from the group consisting of α,β-unsaturated dicarboxylic acids, such as e.g. maleic acid, fumaric acid, itaconic acid or acid anhydrides, acid esters, acid amides or acid imides thereof. Ionomeric copolymers of ethylene and propylene and optionally of further linear α-olefins containing 3 to 8 C atoms with α,β-unsaturated carboxylic acids, such as acrylic acid, methacrylic acid and/or metal salts thereof and/or alkyl esters thereof, or corresponding graft polymers of the monomers mentioned on polymers, or partly hydrolysed ethylene/vinyl ester copolymers, which are optionally graft-polymerized with a monomer of the acids mentioned, are furthermore suitable. The layer thicknesses of the are between 1 and 30 μm, and in a preferred embodiment between 1 and 6 μm. Layer D can optionally comprise the polymers and additives mentioned in the description of layer A or B, but optionally can have a different composition to layer A or B.

The inner layer E comprises as the main component the polymers and additives mentioned in the description of layer A, but optionally has a different composition to layer A. Furthermore, the layer can also contain other substances, preferably coloured pigments. The preferred layer thickness of layer E is less than 10 μm.

To improve the processing properties and the opening properties, additives can be added to the inside layer and/or the outside layer. Antiblocking and lubricating additives above all have proved to be suitable here. These antiblocking additives are based e.g. on a silicon oxide basis.

UV light absorbers can be added to individual layers to reduce the influence of light on the filling. Inorganic pigments, in particular oxides of zinc, titanium, iron and silicon, have proved suitable here. In a preferred embodiment, the inorganic extra-fine pigment is incorporated into the composite by means of a masterbatch, the carrier material of which is compatible with the base material of the layer. The amount of pigment is 0.1 to 5 wt. %, preferably 0.5 to 2.5 wt. %, based on the total weight of the tubular casing.

The natural fibres mixed in can be fibres based on polysaccharides, such as e.g. cellulose fibres from plants, such as e.g. hemp, jute, linen, bamboo, coconut or wood, or also cellulose fibres from regenerated cellulose from the viscose or lyocell process, or natural mineral fibres, such as carbon fibres. Preferably, a cellulose fibre of a hardwood, softwood or conifer having a length of 5-10,000 μm, preferably having a 95% content having the length of 5-35 μm and/or 35-350 μm and/or 350-10,000 μm, particularly preferably having the length of 5-35 μm and/or 350-10,000 μm at a diameter of 2-30 μm, is employed. The fibres can also be employed as a mixture thereof, particularly preferably as a bimodal mixture thereof. The bulk density of such cellulose fibres varies between 20-600 g/l, depending on the fibre length and type. The fibres can be thermally and/or physically and/or chemically pretreated.

The amount of fibres mixed into the layer is between 0.1-70%, preferably between 0.1-10%, and particularly preferably between 0.1-7 per cent by weight. The amount of fibre mixed in can comprise various fibre types and/or fibre lengths, and a mixture of various fibre types and/or fibre lengths is particularly preferred.

The natural fibres can be processed by means of a compound or masterbatch based on an aliphatic polyamide, such as PA6, PA11, PA12, PA66, PA6/66, PA6.8, PA6.9, PA6.10, PA6.11 or PA6.12, and/or other thermoplastics or by direct mixing in. A compound or masterbatch based on a low-melting polyamide, such as PA6/66 and/or PA12, is preferred. The layers of the casing can include additives, such as lubricants, antiblocking agents, nucleating agents, fillers and coloured pigments or a mixture of these.

The masterbatch and/or compound can be prepared as granules or as a powder. The granule form, which can be spherical or cylindrical, is preferred. Cylindrical granules of between 2-7 mm length and 1-4 mm diameter having a porous character, which can be realized by a specific preparation and leads to a reduced shearing force in the smooth and grooved solids zone of the extruder, are particularly preferred. The masterbatch and/or compound can optionally be predried.

The seamless tubular casing can be produced with the aid of the blown film or double bubble process, it being possible for a twin- or single-screw extruder to be used. The double bubble process is preferred. The seamless tubular casing is preferably stretched biaxially with an area stretching ratio of 4-10, and particularly preferably of 6-10, since in these area stretching ratios the fibre orientations have the effect of a particularly high tear propagation resistance with very positive peeling properties. In addition, a particularly good printability is rendered possible at these area stretching ratios, and an excellent tautness and cylindricity of the finished sausage is achieved.

The coextruded tubular casing conventionally has a free shrinkage in at least one orientation direction, measured in a water-bath at 100° C. after 15 min, of between 1 and 35%, in particular between 2 and 20%.

The present invention also provides the use of the seamless tubular casing according to the invention as a wrapping for paste-like or liquid fillings. The particular advantage of a seamless tubular casing is that continuous, spiral-shaped peeling of the sausage is possible without being limited by imperfections, such as, for example, a joining seam. In addition, the visual and haptical impression, the barrier properties and the mechanical integrity of the seamless tubular casing during production of, for example, sausage, are excellent, without being impaired by a seam. The casing is preferably used for packaging sausage goods, animal feed, cheese, doughs or soups.

The subject matter of the invention is to be explained in more detail with the aid of the following examples.

### COMPARISON EXAMPLE 1

A multi-layered seamless tubular casing comprising 3 layers
Layer A: 100% PA6/66 (Ultramid C35F BASF) having a layer thickness of 5 μm
Layer B: 100% PA6/66 (Ultramid C35F BASF) having a layer thickness of 20 μm
Layer C: 93% PA 6 (Durethan B40F Bayer) and 7% antiblocking agent having a layer thickness of 5 μm
   was formed to a primary tube on three single-screw extruders via an annular die. The tube was cooled rapidly and then heated to the minimum temperature required for the stretching, stretched biaxially to a high degree with the aid of compressed air acting on the inside and then heat-set in a further heating zone. It was possible for the mechanical properties of the tube to be adjusted via the heat setting, and the tube had an average wall thickness of 30 μm.

### EXAMPLE 1

A multi-layered seamless tubular casing comprising the following 5 layers:
Layer A: 98% PA6/66 (viscosity number=195, melting point=196° C., film type)+2% cellulose fibres (1% hardwood cellulose of ØL=60 μm and ØD=20 μm and 1% hardwood cellulose of ØL=23 μm and ØD=17 μm) having a layer thickness of 22 μm
Layer B: 100% EVOH (32 mol % ethylene, MFI=1.6 g/10 min) having a layer thickness of 3 μm
Layer C: 100% PA6 (viscosity number=225, film type) having a layer thickness of 12 μm
Layer D: 100% adhesion promoter (anhydrite-modified polyolefin based on LLDPE, melting point=120° C., MFI=1.6 g/10 min) having a layer thickness of 4 μm
Layer E: 97% PA6 (viscosity number=225, film type)+3% antiblocking masterbatch having a layer thickness of 8 μm
   was plasticated and homogenized on 5 single-screw extruders and converted into tube form by means of a 5-layer coextrusion die. The tube was cooled rapidly and then heated to the minimum temperature required for the stretching, stretched biaxially with the aid of compressed air acting on the inside and then heat-set in a further heating zone. It was possible for the mechanical properties of the tube to be adjusted via the heat setting, and the tube had an average wall thickness of 49 μm.

### EXAMPLE 2

A multi-layered seamless tubular casing comprising the following 5 layers:
Layer A: 98% PA6/66 (viscosity number=195, melting point=196° C., film type)+2% cellulose fibres (hardwood cellulose of ØL=23 μm and ØD=17 μm) having a layer thickness of 22 μm
Layer B: 100% EVOH (32mol % ethylene, MFI=1.6 g/10 min) having a layer thickness of 3 μm
Layer C: 100% PA6 (viscosity number=225, film type) having a layer thickness of 12 μm
Layer D: 100% adhesion promoter (anhydrite-modified polyolefin based on LLDPE, melting point=120° C., MFI=1.6 g/10 min) having a layer thickness of 4 μm
Layer E: 97% PA6 (viscosity number=225, film type)+3% antiblocking masterbatch having a layer thickness of 8 μm
   was plasticated and homogenized on 5 single-screw extruders and converted into tube form by means of a 5-layer coextrusion die. The tube was cooled rapidly and then heated to the minimum temperature required for the stretching, stretched biaxially with the aid of compressed air acting on the inside and then heat-set in a further heating zone. It was possible for the mechanical properties of the tube to be adjusted via the heat setting, and the tube had an average wall thickness of 49 μm.

### EXAMPLE 3

A multi-layered seamless tubular casing comprising the following 5 layers:
Layer A: 88% PA6/66 (viscosity number=195, melting point=196° C., film type)+2% cellulose fibres (hardwood cellulose of ØL=23 μm and ØD=17 μm)+10% orange colour masterbatch having a layer thickness of 22 μm
Layer B: 100% EVOH (32 mol % ethylene, MFI=1.6 g/10 min) having a layer thickness of 3 μm
Layer C: 100% PA6 (viscosity number=225, film type) having a layer thickness of 12 μm
Layer D: 100% adhesion promoter (anhydrite-modified polyolefin based on LLDPE, melting point=120° C., MFI=1.6 g/10 min) having a layer thickness of 4 μm

Layer E: 97% PA6 (viscosity number=225, film type)+3% antiblocking masterbatch having a layer thickness of 8 μm

was plasticated and homogenized on 5 single-screw extruders and converted into tube form by means of a 5-layer coextrusion die. The tube was cooled rapidly and then heated to the minimum temperature required for the stretching, stretched biaxially with the aid of compressed air acting on the inside and then heat-set in a further heating zone. It was possible for the mechanical properties of the tube to be adjusted via the heat setting, and the tube had an average wall thickness of 49 μm.

### EXAMPLE 4

A multi-layered seamless tubular casing comprising 3 layers
Layer A: 100% PA6/66 (viscosity number=195, melting point=196° C., film type) having a layer thickness of 5 μm
Layer D: 97% PA6/66 (viscosity number=195, melting point=196° C., film type) and 3% cellulose fibres (1.5% hardwood cellulose of ØL=60 μm and ØD=20 μm and 1.5% hardwood cellulose of ØL=23 μm and ØD=17 μm) having a layer thickness of 20 μm
Layer E: 97% PA6 (viscosity number=225, film type) and 3% antiblocking masterbatch having a layer thickness of 6 μm
   was formed to a primary tube on three single-screw extruders via an annular die. The tube was cooled rapidly and then heated to the minimum temperature required for the stretching, stretched biaxially to a high degree with the aid of compressed air acting on the inside and then heat-set in a further heating zone. It was possible for the mechanical properties of the tube to be adjusted via the heat setting, and the tube had an average wall thickness of 30 μm.

### EXAMPLE 5

A multi-layered seamless tubular casing comprising 5 layers
Layer A: 100% PA6/66 (viscosity number=195, melting point=196° C., film type) having a layer thickness of 5 μm
Layer B: 100% PA6/66 (viscosity number=195, melting point=196° C., film type) having a layer thickness of 20 μm
Layer C: 100% PA6 (viscosity number=225, film type) having a layer thickness of 5 μm
Layer D: 98% PA6/66 (viscosity number=195, melting point=196° C., film type) and 2% cellulose fibres (1% hardwood cellulose of ØL=60 μm and ØD=20 μm and 1% hardwood cellulose of ØL=23 μm and ØD=17 μm) having a layer thickness of 5 μm
Layer E: 93% PA6 (viscosity number=225, film type) and 7% antiblocking masterbatch having a layer thickness of 6 μm
   was formed to a primary tube on 5 single-screw extruders via an annular die. The tube was cooled rapidly and then heated to the minimum temperature required for the stretching, stretched biaxially to a high degree with the aid of compressed air acting on the inside and then heat-set in a further heating zone. It was possible for the mechanical properties of the tube to be adjusted via the heat setting, and the tube had an average wall thickness of 41 μm.

### EXAMPLE 6

A multi-layered seamless tubular casing comprising 5 layers
Layer A: 97% PA6/66 (viscosity number=195, melting point=196° C., film type) and 3% cellulose fibres (1.5% hardwood cellulose of ØL=60 μm and ØD=20 μm and 1.5% hardwood cellulose of ØL=23 μm and ØD=17 μm) having a layer thickness of 5 μm
Layer B: 100% PA6/66 (viscosity number=195, melting point=196° C., film type) having a layer thickness of 20 μm
Layer C: 100% PA6 ((viscosity number=225, film type) having a layer thickness of 5 μm
Layer D: 98% PA6/66 (viscosity number=195, melting point=196° C., film type) and 2% cellulose fibres (1% hardwood cellulose of ØL=60 μm and ØD=20 μm and 1% hardwood cellulose of ØL=23 μm and ØD=17 μm) having a layer thickness of 5 μm
Layer E: 93% PA6 (viscosity number=225, film type) and 7% antiblocking masterbatch having a layer thickness of 6 μm
   was formed to a primary tube on 5 single-screw extruders via an annular die. The tube was cooled rapidly and then heated to the minimum temperature required for the stretching, stretched biaxially to a high degree with the aid of compressed air acting on the inside and then heat-set in a further heating zone. It was possible for the mechanical properties of the tube to be adjusted via the heat setting and the tube had an average wall thickness of 41 μm.

### REFERENCE EXAMPLE 1

This is the commercial product of synthetic gut Walsroder “K plus” having 5 layers and a total layer thickness of 49 μm from CaseTech GmbH & Co. KG.

### REFERENCE EXAMPLE 2

The commercial product Walsroder “F plus” from CaseTech GmbH & Co. KG. This is a cellulose fibre gut lacquered on the inside (PVDC).

Test Criteria:

Casing sections were soaked in water for 30 min and then filled with fine-grained scalding sausage meat under a constant filling pressure and closed with metal clips at the ends. The sausages were then hung up, treated with smoke-saturated water vapour at 75° C. for 30 min in scalding cabinet with a smoke generator and subsequently cooked thoroughly at 80° C. for 60 min with water vapour without smoke. The sausages were cooled to room temperature in air and then stored in a refrigerated chamber at about 6° C. Table 1 shows the evaluation of the results.

TABLE 1

| | CE | | | | | | | RE | RE |
|---|---|---|---|---|---|---|---|---|---|
| | 1 | E 1 | E 2 | E 3 | E 4 | E 5 | E 6 | 1 | 2 |
| Permeability to water vapour | 30 | 5 | 5 | 5 | 32 | 14 | 15 | 4 | 5 |
| (g · m⁻² · d⁻¹) | | | | | | | | | |
| Permeability to oxygen | 40 | 4 | 4 | 4 | 44 | 24 | 26 | 4 | 40 |
| (ml · m⁻² · d⁻¹ · bar⁻¹) | | | | | | | | | |
| Weight loss | 2 | 1 | 1 | 1 | 2 | 2 | 2 | 1 | 1 |
| Peeling properties | 2 | 1 | 1 | 1 | 1 | 1 | 1 | 2 | 1 |
| Cylindricity | 1 | 1 | 1 | 1 | 1 | 1 | 1 | 1 | 1 |
| Nat. visual properties | 6 | 1 | 1 | 1 | 1 | 1 | 1 | 6 | 1 |
| Nat. haptical properties | 6 | 1 | 1 | 1 | 2 | 2 | 1 | 6 | 1 |
| Colour covering | 2 | 2 | 2 | 2 | 2 | 1 | 2 | 1 | 1 |
| Slicing properties (hot) | 4 | 1 | 1 | 1 | 1 | 1 | 1 | 6 | 6 |
| Tear propagation properties | 4 | 1 | 1 | 1 | 1 | 1 | 1 | 4 | 6 |
| Dipping properties | 5 | 1 | 1 | 1 | 1 | 1 | 1 | 5 | 5 |
| Surface structure | 6 | 1 | 1 | 1 | 2 | 2 | 1 | 6 | 1 |
| Ring properties | 2 | 2 | 2 | 2 | 1 | 1 | 1 | 2 | 6 |

Evaluation:
1 = very good
2 = good
3 = satisfactory
4 = sufficient
5 = deficient
6 = very deficient

The relevant properties of the multi-layered seamless tubular casing described in the following were determined as follows:

Permeability to water vapour: In accordance with ASTM F1249-01 at a temperature of 23° C. and a relative atmospheric humidity of 85%. The value indicates the amount of water vapour in grams which passes through a 1 m² area of the casing to be tested during one day (24 hours) under the stated test conditions.

Permeability to oxygen: The \overline{O}2Pe is determined in accordance with DIN 53380 Part 3 at a temperature of 23° C. and a relative atmospheric humidity of 75%. The value indicates the volume of oxygen in millilitres which passes through a 1 m² area of the casing to be tested during one day (24 hours) under an oxygen partial pressure of 1 bar under the stated test conditions.

Weight loss: The casings to be tested are filled taut with oxidation-sensitive test filling (test cooking product based on scalding sausage) by means of a commercially available filling machine and closed on both sides by a clip. After weighing of the sausages obtained, these are stored in a storage chamber at room temperature. At the end of 20 days, the sausages are weighed again, the percentage weight loss resulting from the ratio of the difference in weight before and after storage to the weight before storage (school note principle).

Peeling properties: It was evaluated how easily the casing could be peeled off after being cut into and how good the peeling properties (e.g. change in direction during peeling) were (school note principle).

Cylindricity: Objective judgment via the difference in calibre between the sausage diameter at the top, middle and bottom (school note principle)

Natural visual properties: Subjective judgment via the visual impression, such as wrinkling and consistency of the sausages (school note principle)

Natural haptical properties: Subjective judgment via the haptical impression, such as firm handle and natural surface of the sausages (school note principle)

Colour covering: Subjective judgment via the colour intensity and colour accuracy of the filled coloured sausage casing before and after scalding (school note principle)

Slicing properties (hot): Objective judgment via the number and length of the tears caused during hot slicing (core temperature of the cooking product approx. 35° C.) (school note principle)

Tear propagation resistance: The casings to be tested are filled taut with test cooking product based on scalding sausage by means of a commercially available filling machine, and closed on both sides by a clip. After scalding and cooling, the samples approx. 50 cm long are halved and each half is cut into approx. 1 cm in the longitudinal direction at the sliced end. The samples are then stored hot at a temperature of 70° C. and a relative humidity of 30% for several hours. Evaluation is via the length of tear which develops during storage.

Dipping properties: Objective judgment via the number of torn or burst sausages during filling or scalding after cold dipping (school note principle)

Surface structure: Subjective judgment via the surface structure of the sausage (school note principle)

Ring properties: Objective judgment via the ring formation properties (school note principle)

1. At least three-layered, coextruded, tubular, biaxially stretched seamless tubular casing comprising, viewed from the outside inwards,
a) an outer layer A which comprises as the main component a polyamide or a mixture of several polyamides,
b) optionally a layer B which has an oxygen-blocking character,
c) optionally a core layer C which comprises as the main component a polyamide or a mixture of several polyamides,
d) a layer D which has an adhesion-promoting action with respect to the adjacent layer C or B or A and the adjacent layer E and
e) an inner layer E which comprises as the main component a polyamide or a mixture of several polyamides,
f) optionally further layers and additives, wherein
g) at least one layer comprises natural fibres having a fibre length in the range of from 5 to 10,000 μm and/or a natural fibre mixture of various fibre types and/or fibre lengths.

2. Seamless tubular casing according to claim 1, characterized in that the main components of layer A comprise either an aliphatic homopolyamide or an aliphatic copolyamide or a blend of aliphatic homo- and copolyamide or a blend of aliphatic homopolyamide and a partly aromatic polyamide.

3. Seamless tubular casing according to claim 2, characterized in that the partly aromatic polyamides used are substantially built up from m-xylylenediamine units and adipic acid units or from units of hexamethylenediamine, isophthalic acid and terephthalic acid.

4. Seamless tubular casing according to claim 1, characterized in that the natural fibres are cellulose fibres.

5. Seamless tubular casing according to claim 1, characterized in that the natural fibres are contained in at least one of the layers in an amount of from 0.1 to 70 wt. %, based on the total weight of the layer.

6. Seamless tubular casing according to claim 1, characterized in that layer D comprises modified homo- and/or copolymers of α-olefins having 2 to 8 C atoms, which contain grafted-on or copolymerized monomers from the group consisting of α,β-unsaturated dicarboxylic acids and/or monocarboxylic acids and/or derivatives thereof, or an aliphatic homopolyamide or an aliphatic copolyamide or a blend of aliphatic homo- and copolyamide or a blend of aliphatic homopolyamide and a partly aromatic polyamide.

7. Seamless tubular casing according to claim 1, characterized in that layer B comprises an approximately completely hydrolyzed ethylene/vinyl acetate copolymer (EVOH) having an ethylene content of between 25 and 53% by weight or modified homo- and/or copolymers of α-olefins having 2 to 8 C atoms, which contain grafted-on or copolymerized monomers from the group consisting of α,β-unsaturated dicarboxylic acids and/or monocarboxylic acids and/or derivatives thereof, an aliphatic homopolyamide or an aliphatic copolyamide or a blend of aliphatic homo- and copolyamide or a blend of aliphatic homopolyamide and a partly aromatic polyamide.

8. Seamless tubular casing according to claim 1, characterized in that layer C comprises an aliphatic homopolyamide or an aliphatic copolyamide or a blend of aliphatic homo- and copolyamide or a blend of aliphatic homopolyamide and a partly aromatic polyamide or optionally a polyolefin homo- or copolymer or a blend of these.

9. Seamless tubular casing according to claim 1, characterized in that layer E comprises an aliphatic homopolyamide or an aliphatic copolyamide or a blend of aliphatic homo- and copolyamide or a blend of aliphatic homopolyamide and a partly aromatic polyamide.

10. Seamless tubular casing according to claim 1, characterized in that the sum of all the layer thicknesses is 25 to 80 μm.

11. Seamless tubular casing according to claim 1, characterized in that this is heat-set.

12. (canceled)

13. (canceled)

14. Seamless tubular casing according to claim 1, characterized in that layer B comprises an approximately completely hydrolyzed ethylene/vinyl acetate copolymer (EVOH) having an ethylene content of between 29 and 38% by weight and a thickness between 3 and 6 μm.

15. A wrapping material for paste-like and liquid fillings which comprises the casing as claimed in claim 1.

16. The wrapping material as claimed in claim 15, wherein the paste-like filling is sausage meat.

17. Seamless tubular casing according to claim 1, wherein said layer D has a thickness between 1 and 6 μm.

18. Seamless tubular casing according to claim 1, wherein said layer E has a thickness less than 10 μm.

19. Seamless tubular casing according to claim 14, wherein said layer D has a thickness between 1 and 6 μm. and said layer E has a thickness less than 10 μm and the sum of all the layer thicknesses is 25 to 80 μm.
